(19) United States
(12) Patent Application Publication
(10) Pub. No.: US 2012/0124378 A1
(43) Pub. Date: May 17, 2012

(54) METHOD FOR PERSONAL IDENTITY AUTHENTICATION UTILIZING A PERSONAL CRYPTOGRAPHIC DEVICE

(75) Inventor: YENG MING CHANG, TAIPEI COUNTY (TW)

(73) Assignee: XAC AUTOMATION CORP., HSINCHU (TW)

(21) Appl. No.: 12/944,980

(22) Filed: Nov. 12, 2010

(51) Int. Cl. H04L 9/32; H04L 9/28; H04L 9/08

(52) U.S. Cl. 713/172

(57) ABSTRACT

A method for personal identity authentication utilizing a personal cryptographic device initially provides a personal cryptographic device storing a client key from a host system and a device serial number. Next, the personal cryptographic device is connected to the host system. Thereafter, unique user information is inputted via the personal cryptographic device. Then, the unique user information and the device serial number are encrypted and sent to the host system for authentication and for requesting key information. The personal cryptographic device receives and decrypts encrypted key information with the client key, and changes the client key using the key information.

### BACKGROUND OF THE INVENTION

1. Field of the Invention

The present invention relates to a method for personal identity authentication.

2. Description of the Related Art

The convenience of the internet facilitates the development of many network-based systems providing services, such as e-commerce services, mobile computing services, and cloud computing services. Users requiring such services can be served anytime or anywhere by the network-based systems. Generally, the network-based systems that can be operated at low security levels use a username/password scheme for authenticating users, while the network-based systems that need high security levels usually further require users to input their personal credential information for verifying their identities.

Users may be requested to prepare more than one personal credential to access the systems operating at high security level. For example, a credit card payment system over a network may ask for cardholder credentials other than a credit card number for authentication. For ease of memorization, users generally use their most-familiar personal data, such as their birthday, address numbers, government ID numbers, passport numbers or driver's license numbers as the credentials. However, such credentials may be easily compromised.

### SUMMARY OF THE INVENTION

One objective of the present invention is to provide a cryptographic device and method for improving the security of authentication procedures over a network.

Another objective of the present invention is to provide a device and method for providing secured communication that is secure, convenient, and easy to implement to authenticate internet users.

To achieve the above objectives, the present invention discloses a method for personal identity authentication utilizing a personal cryptographic device. The method comprises the steps of providing a personal cryptographic device storing a device serial number and a client key from a host system; connecting the personal cryptographic device to the host system through a communication network; inputting unique user information via the personal cryptographic device; encrypting the unique user information and the device serial number with the client key; transmitting the encrypted unique user information and encrypted device serial number to the host system for requesting key information; receiving encrypted key information; and decrypting the encrypted key information and changing the client key using the key information.

The present invention discloses a personal cryptographic device connectable to a host system. The personal cryptographic device includes a storage module configured to store a client key and a device serial number, a data entry module configured to allow a user to input unique user information, an encryption/decryption module configured to encrypt the device serial number and the unique user key with the client key; and an authentication configured to request new key information using the encrypted device serial number and encrypted unique user information.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 shows a transaction authentication system according to one embodiment of the present invention;

FIG. 2 is a block diagram schematic of one embodiment of a personal cryptographic device;

FIG. 3 is a block diagram schematic of one embodiment of a host system;

FIG. 4 is a process flow chart summarizing the major processing steps of a personal identity authentication process implemented in one embodiment of the cryptographic device of the present invention; and

FIG. 5 is a process flow chart summarizing the major processing steps of an identification process implemented in one embodiment of the host system of the present invention.

### DETAILED DESCRIPTION OF THE INVENTION

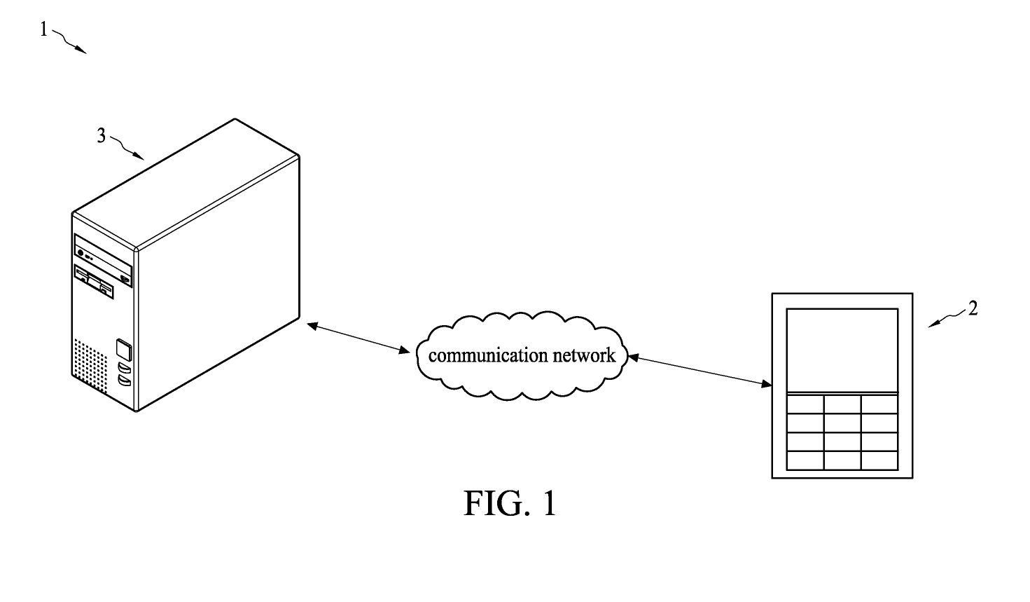

FIG. 1 shows a transaction authentication system 1 according to one embodiment of the present invention. One embodiment of the present invention discloses a personal cryptographic device 2, which is configured to be able to renew its cryptographic data, and allow a user to use his unique user information and its device serial number to perform a secure transaction over a communication network with a host system 3. The personal cryptographic device 2 can be embodied in many different forms based on its application. The personal cryptographic device 2 can be embodied as an independently operable computing device such as a cell phone, notebook computer, personal digital assistant (PDA), or a device such as a secure key pad operatively depending on a network computing device. If the personal cryptographic device 2 is an operatively dependent device, the personal cryptographic device 2 is configured to be connected in a removable manner. Specifically, the personal cryptographic device 2 can include a male/female pair of connectors for attaching to a network computing device that is used to assist in performing a secure transaction. The network computing device can be a computer, which is capable of communicating over a network. In the embodiments of the present invention, any female-male coupling type for an electrical connector system in the present art can be applied to the personal cryptographic device 2.

The communication network can be a cellular network if the personal cryptographic device 2 is embodied as a cell phone, a data communication network if the personal cryptographic device 2 is embodied as a computer or a key pad, or a telecommunications network.

Furthermore, in one embodiment, the personal cryptographic device 2 can be a tamper-resistant device so that the personal cryptographic device 2 can be protected from unauthorized modification, inspection, or forgery.

In another embodiment, the personal cryptographic device 2 can have tamper-responsive features that can typically detect any attempt to disassemble or penetrate the personal cryptographic device 2, for example, by detecting penetration of a conducting mesh surrounding the personal cryptographic device 2, by detecting the removal of screws or other fixtures holding the personal cryptographic device 2 together, or by detecting the cutting of any conductive wires. The tamper-responsive features are typically connected to an erase pin on a non-volatile memory storing encryption data. Thus, the personal cryptographic device 2 may be tamper-responsive for destroying the stored encryption in the event that the personal cryptographic device 2 is tampered with.

In one embodiment of the present invention, the personal cryptographic device 2 can be configured to allow a user to input his unique user information for login authentication. In one embodiment, the unique user information can be a personal identification number (PIN) or a password.

The personal cryptographic device 2 is also configured to have decryption/encryption function for securing transaction data. Before transmission, the secure data is encrypted by the encrypt key of the personal cryptographic device 2 and is then sent. After receiving encrypted secure data, the encrypt key of the personal cryptographic device 2 decrypts the encrypted secure data.

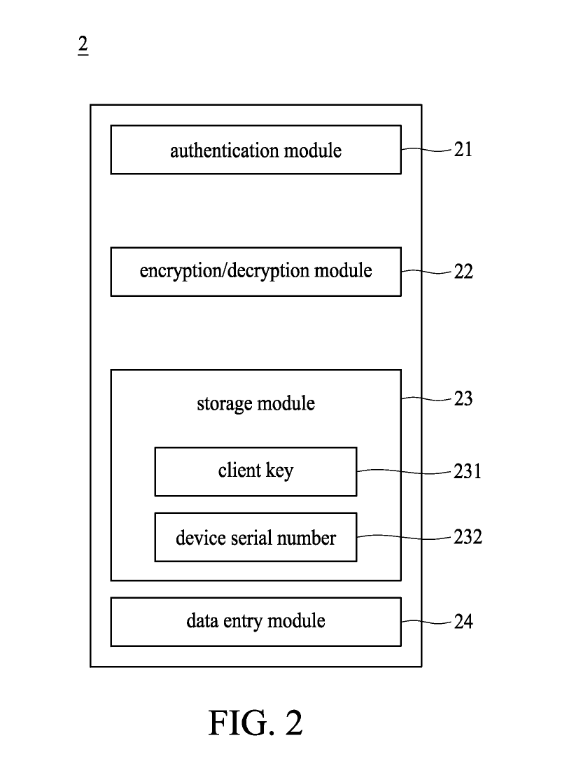

FIG. 2 is an electronic block diagram schematic of one embodiment of a personal cryptographic device 2. Referring to FIGS. 1 and 2, the personal cryptographic device 2 comprises an authentication module 21, an encryption/decryption module 22, a storage module 23, and a data entry module 24. The encryption/decryption module 22 is configured for encrypting and decrypting secure transmission data to and from the host 3. The storage module 23 may be used for storing data including, for example, a device serial number 232 and a client key 231 for cryptographically secure data transmission. The data entry module 24 is configured to allow a user to input his unique user information. The authentication module 21 is configured to submit authentication and new key information requests to the host system 3 via a communication network using the encrypted device serial number and encrypted unique user information.

In one embodiment, the personal cryptographic device 2 may include a keyboard or touch panel for inputting a user's unique user information.

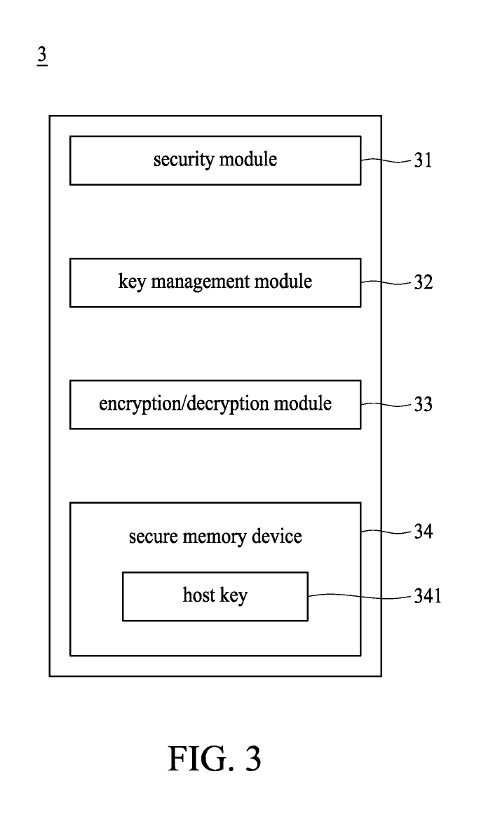

Correspondingly, the transaction authentication system 1 may include the host system 3. As shown in FIG. 3, the host system 3 may include a security module 31, a key management module 32, an encryption/decryption module 33, and a secure memory device 34 storing a host key 341. The security module 31 is configured for authenticating users to access the host system 3. The key management module 32 is configured for generating cryptographic keys. The encryption/decryption module 33 is configured for encrypting and decrypting secure transmission data. The host key 341 is used for encrypting or decrypting secure data.

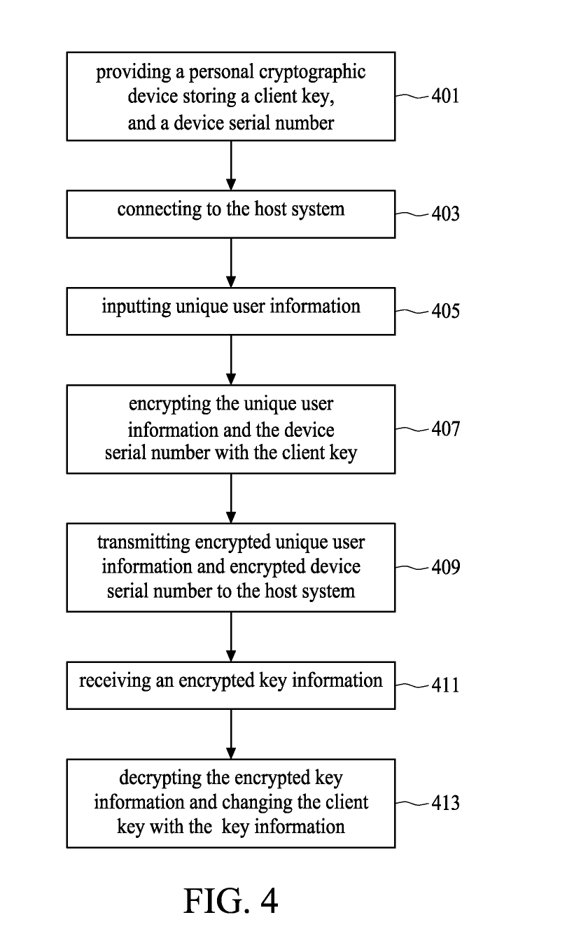

FIG. 4 is a process flow chart summarizing the major processing steps of a personal identity authentication process implemented in one embodiment of the cryptographic device 2 of the present invention.

Referring to FIGS. 1 to 4, in Step 401, a user is provided with a personal cryptographic device 2 by the owner of the host system 3. The personal cryptographic device 2 may include a device serial number 232 that is stored in the storage module 23 of the personal cryptographic device 2. A client key 231 generated by the key management module 32 of the host system 3 and paired with a host key 341 is also stored into the storage module 23 of the personal cryptographic device 2.

In Step 403, after a user receives a personal cryptographic device 2, the personal cryptographic device 2 can be connected to the host system 3 through a communication network. If the personal cryptographic device 2 is an operatively dependent device, the user can attach the personal cryptographic device 2 to a network computing device so as to connect to the host system 3 through the network computing device. If the personal cryptographic device 2 is an operatively independent device, the user can connect directly to the host system 3 using the personal cryptographic device 2.

In Step 405, after connecting to the host system 3, the user may input his unique user information into the personal cryptographic device 2 by the data entry module 24. The unique user information is used for login authentication. The unique user information is stored in the host system 3 for login authentication when the user registers to the owner of the system 3.

In Step 407, the encryption/decryption module 22 encrypts the unique user information and the device serial number 232 with the client key 231. The unique user information and the device serial number 232 can be encrypted using a crypto algorithm including RSA, data encryption standard (DES), triple data encryption standard (TDES), or advanced encryption standard (AES) algorithm.

In Step 409, the authentication module 21 transmits the encrypted unique user information and the encrypted device serial number 232 to the host system 3 for requesting authentication and key information. Using the two credentials, the encrypted unique user information and the encrypted device serial number 232, for authentication can improve the security of authentication. With the usage of the device serial number 232, the user does not have to prepare two personal credentials. Thus, the user need not memorize two personal credentials, and the risk of identity theft associated with use of familiar personal data for the credential information can be reduced.

In Step 411, after the host system 3 verifies the unique user information and the device serial number 232, the host system 3 transmits encrypted key information to the personal cryptographic device 2. The personal cryptographic device 2 receives the encrypted key information and stores it to the storage module 23. In one embodiment, the key information may be a unique user key, which can be used to replace the client key 231 in use. In another embodiment, the key information may be used to generate a new key for replacing the client key 231 in use. For example, the key information may include a cryptogram and at least one key serial number, and the personal cryptographic device 2 can rely on the cryptogram and the at least one key serial number to generate, by a derived unique key per transaction (DUKPT) key management scheme, a future key to replace the client key 231.

In Step 413, the encryption/decryption module 22 of the personal cryptographic device 2 decrypts the key information using a crypto algorithm such as RSA, data encryption standard (DES), triple data encryption standard (TDES), or advanced encryption standard (AES) algorithm. After decryption, the key information is stored in the storage module 23 and used to change the client key 231. Thereafter, a new client key 231 is used for encrypting or decrypting the user's secure data transmitted to or received from the host system 3 in subsequent communication with the host system 3.

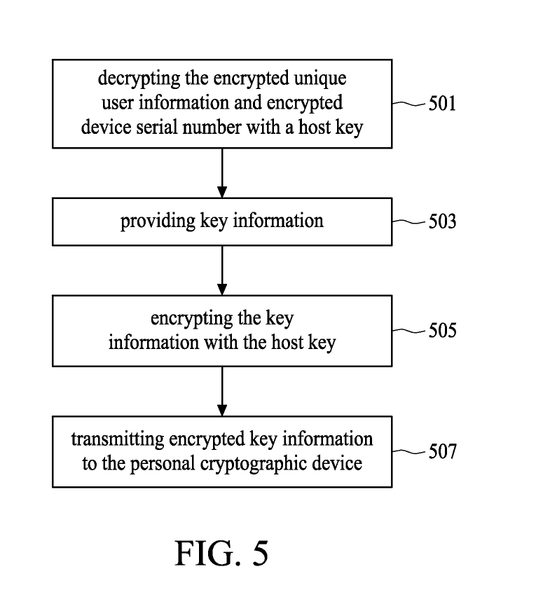

FIG. 5 is a process flow chart summarizing the major processing steps of an identification process implemented in one embodiment of the host system 3 of the present invention. In Step 501, after the host system 3 receives the encrypted unique user information and the encrypted device serial number 232 from the personal cryptographic device 2 for requesting authentication, the encryption/decryption module 32 of the host system 3 uses the host key 341 to decrypt the encrypted unique user information and the encrypted device serial number 232. The encryption/decryption algorithm used by the host system 3 can be RSA, data encryption standard (DES), triple data encryption standard (TDES), or advanced encryption standard (AES) algorithm. The unique user information and the device serial number 232 are then used by the security module 31 for identification of the user.

In Step 503, after the identification process is complete, the key management module 32 of the host system 3 provides key information for changing the client key. In one embodiment, the scheme used by the host system 3 to generate the key information can be a derived unique key per transaction (DUKPT) key management scheme or master/session key management scheme.

In Step 505, the encryption/decryption module 32 of the host system 3 encrypts the key information with the host key. The encryption algorithm can be RSA, data encryption standard (DES), triple data encryption standard (TDES), or advanced encryption standard (AES) algorithm.

In Step 507, after the key information is encrypted, the encrypted key information is transmitted to the corresponding personal cryptographic device 2.

In one embodiment, the cryptographic method used for secure data transmitted between the host system 3 and the personal cryptographic device 2 can be public key cryptography. In such instance, the host key 341 can be a private key, and the client key 231 can be a public key.

In one embodiment of the present invention, the transaction authentication system 1 can adopt the derived unique key per transaction (DUKPT) scheme for managing keys. In such embodiment, the key information may include a cryptogram and at least one key serial number, which are used to generate at least one future key used for replacing the client key 231 based on a derived unique key per transaction (DUKPT) key management scheme.

In one embodiment of the present invention, the transaction authentication system 1 can adopt a master/session key management scheme.

In addition, the client key 231 in the personal cryptographic device 2 can be renewed at every login. In other words, at every login, the unique user information and the device serial number 232 are encrypted and transmitted to the host system 3. After the unique user information and the device serial number 232 are verified and the user is identified, the host system 3 sends encrypted new key information to the personal cryptographic device 2 for changing the client key 231. After the client key is changed, transaction data can be encrypted using the new client key.

In one embodiment, the client key 231 may be changed before an authentication request is made or a new transaction is performed. The host system 3 can be authorized, on its own accord, to send new key information to the personal cryptographic device 2 for changing the client key before an authentication request is made or a new transaction is performed; or the personal cryptographic device 2 can request the host system 3 to send new key information for changing the client key before an authentication request is made or a new transaction is performed.

In another embodiment, the client key can be changed during the establishment of connection between the network device attached to the personal cryptographic device 2 and the host system 3. Similarly, the host system 3 can be authorized, on its own accord, to send new key information to the personal cryptographic device 2 for changing the client key after a period of time expires; or the personal cryptographic device 2 can request the host system 3 to send new key information for changing the client key after a period of time expires.

In a user session, there may be more than one transaction. For securing the transactions, the encrypted transaction data can be sent together with the encrypted device serial number 232 for further identification of the user identity in every transaction in a user session. In another embodiment, the first one of the transactions in a user session is encrypted and sent together with the encrypted device serial number 232. The subsequent transactions are encrypted and sent without the encrypted device serial number 232.

In summary, the device serial number of a personal cryptographic device is used for authentication of user identity in transactions and for acquiring key information for changing a client key. Accordingly, an authentication process or a transaction can be more secure. The client key, used to encrypt secure data transmitted between a host system and the personal cryptographic device, can be regularly changed for further improving the security. The client key in the personal cryptographic device can be changed in every transaction or authentication, changed in the first one of the transactions in a user session, or changed at predetermined time intervals such as every ten minutes while the personal cryptographic device is in connection with the host system.

Clearly, following the description of the above embodiments, the present invention may have many modifications and variations. Therefore, the scope of the present invention shall be considered with the scopes of the dependent claims. In addition to the above detailed description, the present invention can be broadly embodied in other embodiments. The above-described embodiments of the present invention are intended to be illustrative only, and should not become a limitation of the scope of the present invention. Numerous alternative embodiments may be devised by persons skilled in the art without departing from the scope of the following claims.

What is claimed is:

1. A method for personal identity authentication utilizing a personal cryptographic device, comprising the steps of:
providing a personal cryptographic device storing a device serial number and a client key from a host system;
connecting the personal cryptographic device to the host system through a communication network;
inputting unique user information via the personal cryptographic device;
encrypting the unique user information and the device serial number with the client key;
transmitting encrypted unique user information and encrypted device serial number to the host system for requesting key information;
receiving encrypted key information; and
decrypting the encrypted key information and changing the client key using the key information.

2. The method of claim 1, further comprising the steps of:
decrypting the encrypted unique user information and encrypted device serial number with a host key by the host system;
providing key information after the validation of the unique user information and the device serial number;
encrypting the key information with the host key; and
transmitting encrypted key information to the personal cryptographic device.

3. The method of claim 2, further comprising a step of transmitting new key information to the personal cryptographic device for changing the client key during the connection between the personal cryptographic device and the host system.

4. The method of claim 2, wherein the client key is a public key, and the host key is a private key.

5. The method of claim 2, wherein the key information includes a unique user key paired with the host key.

6. The method of claim 1, wherein the personal cryptographic device is a tamper-resistant device.

7. The method of claim 1, wherein the personal cryptographic device is a tamper-responsive device.

8. The method of claim 1, wherein the personal cryptographic device is connected to a network computing device in a removable manner.

9. The method of claim 1, wherein the personal cryptographic device is embodied as a PDA, a cell phone, a notebook computer, or a keypad.

10. The method of claim 1, wherein the personal cryptographic device performs encryption and decryption using a crypto algorithm including RSA, data encryption standard (DES), triple data encryption standard (TDES), or advanced encryption standard (AES) algorithm.

11. The method of claim 2, wherein the step of generating key information uses a derived unique key per transaction (DUKPT) key management scheme or master/session key management scheme.

12. The method of claim 1, wherein the key information includes a cryptogram and at least one key serial number, which are used to generate at least one future key used for replacing the client key based on a derived unique key per transaction (DUKPT) key management scheme.

13. The method of claim 1, further comprising a step of acquiring key information by the personal cryptographic device at every login or when making an authentication request.

14. The method of claim 1, further comprising a step of transferring encrypted transaction data with the encrypted device serial number to the host system in every transaction.

15. The method of claim 1, further comprising a step of transferring encrypted transaction data with the encrypted device serial number to the host system in the first transaction in a user session.

16. The method of claim 1, wherein the communication network is a cellular network, a data communications network, or a telecommunications network.

17. A personal cryptographic device connectable to a host system, comprising:
a storage module configured to store a client key and a device serial number;
a data entry module configured to allow a user to input unique user information;
an encryption/decryption module configured to encrypted the device serial number and the unique user key with the client key; and
an authentication configured to request new key information using the encrypted device serial number and encrypted unique user information.

18. The personal cryptographic device of claim 17, wherein the client key is a public key or a unique user key paired with a host key stored in the host system.

19. The personal cryptographic device of claim 17, configured as a tamper-resistant device or a tamper-responsive device.

20. The personal cryptographic device of claim 17, configured to be connected to a network computing device in a removable manner or embodied as a PDA, a cell phone, a notebook computer, or a keypad.
